(19) United States
(12) Patent Application Publication
(10) Pub. No.: US 2011/0045823 A1
(43) Pub. Date: Feb. 24, 2011

(54) METHOD FOR TRANSMITTING AND RECEIVING INFORMATION OF RELATION BETWEEN HOME BASE STATIONS

(75) Inventors: Hong Wang, Beijing (CN); Huarui Liang, Beijing (CN); Lixiang Xu, Beijing (CN)

Correspondence Address: Jefferson IP Law, LLP, 1130 Connecticut Ave., NW, Suite 420, Washington, DC, 20036, US

(73) Assignees: SAMSUNG ELECTRONICS CO. LTD., Suwon-si (KR); BEIJING SAMSUNG TELECOM R&D CENTER, Beijing (CN)

(21) Appl. No.: 12/860,365

(22) Filed: Aug. 20, 2010

(30) Foreign Application Priority Data
Aug. 20, 2009 (CN) 200910165972.5

(51) Int. Cl. H04W 40/00; H04W 24/00

(52) U.S. Cl. 455/424; 455/422.1

(57) ABSTRACT

An apparatus and method for transmitting and receiving information regarding the relation between home base stations. The method includes sending, by a first entity, a message to a second entity, wherein the message comprises an identity of the first entity, and sending, by the second entity, a message to the first entity, wherein the message comprises information indicating whether an adjacent home base station and the first entity are serviced by a same gateway.

### PRIORITY

This application claims the benefit under 35 U.S.C. §119(a) of a Chinese patent application filed on Aug. 20, 2009 in the Chinese Intellectual Property Office and assigned Serial No. 200910165972.5, the entire disclosure of which is hereby incorporated by reference.

### BACKGROUND OF THE INVENTION

1. Field of the Invention

The present invention relates to the communication field. More particularly, the present invention relates to a method for transmitting and receiving information regarding the relation between home base stations.

2. Background of the Invention

With the development of communication technologies, a mobile communication system has been evolved into a System Architecture Evolution (SAE) system. The SAE system includes an Evolved Universal Terrestrial Radio Access Network (E-UTRAN) and a core network. A schematic diagram of an SAE system is as shown in FIG. 1.

FIG. 1 is a structure of a home base station in a Long Term Evolution (LTE) system according to the related art.

Referring to FIG. 1, each evolved Node B (eNB) 101, 103, 105 belongs to a radio access network, is adapted to provide a handset with a radio interface for accessing the SAE system, and connects with a Mobility Management Entity (MME) and a Subscriber Gateway (S-GW) 111, 113 respectively through an S1 interface. The MME is adapted to manage mobility contexts and session contexts of User Equipment (UE), and store user information related to security. The S-GW is adapted to provide functions of a subscriber plane. The MME and the S-GW may be in the same physical entity as is illustrated in FIG. 1. Generally, the S-GW transmits user data streams through a GPRS Tunneling Protocol (GTP) to an eNB to which the UE belongs, and then the eNB transmits the user data streams to the UE.

An Evolved Packet Core (EPC) is an evolved core network, and includes an MME and an S-GW. Each eNB (101, 103, 105) is connected with multiple MMEs in an MME pool, and is also connected with multiple S-GWs in an S-GW pool. An interface between eNBs 101, 103, 105 is called as an X2 interface.

A home base station is a base station that is designated for a specific location such as a university, a company, and the like. The home base station is a plug and play device, and includes a Home eNode B (HeNB) and a Home Node B (HNB). As illustrated in FIG. 1, HeNBs 131, 133, 135 are home base stations applied to a Long Term Evolution (LTE) system, and connect with a home base station gateway 121 through an S1 interface. The home base station gateway 121 connects with an MME/S-GW 111, 113 through an S1 interface. Hereinafter, the home base station gateway is called a gateway for short. The HNB is a home base station applied to a Universal Mobile Telecommunications System (UMTS), and connects with the gateway through an Iᵤh interface. The gateway connects with a Service GPRS Supporting Node (SGSN) through an Iᵤ interface.

A difference between a home base station and a general macro base station lies in the fact that not all UEs can access the HeNB. For example, only a user's UE or another UE that is permitted by the user may access the user's home base station. Similarly, for a home base station located in a company, only the staff in the company and partners allowed by the company can access the company's home base station. A group of home base stations having the same accessing user group (e.g. home base stations used in the same company) is called as a Closed Subscriber Group (CSG). Each CSG has a CSG identity (CSG ID), which can exclusively identify one CSG. The CSG ID is broadcast as part of broadcast information of the HeNB, and a UE stores a list of CSG IDs to which the user is allowed to access.

It often occurs that a UE moves from one home base station to another home base station, for example as a UE moves between floors or other locations in a company. If the UE is in a connected state and is performing a certain service, the user desires that the service not be interrupted when the UE moves to another home base station. Thus, a handover procedure between home base stations is important.

If the handover procedure between home base stations is performed under the same base station gateway, it is desirable that a Core Network (CN) not participate in the handover procedure in order to decrease a load on the CN. However, some information that is needed by a target home base station can not be generated by the gateway. For example, in the UMTS, the target home base station needs to obtain encryption information from the CN, but the gateway can not generate the encryption information according to the current specifications. Accordingly, there is a need for an improved apparatus and method for transmitting and receiving information regarding the relation between home base stations.

### SUMMARY OF THE INVENTION

An aspect of the present invention is to address at least the above-mentioned problems and/or disadvantages and to provide at least the advantages described below. Accordingly, an aspect of the present invention is to provide a method for transmitting and receiving information of a relation between home base stations.

In accordance with an aspect of the present invention, a method for transmitting and receiving information of a relation between home base stations is provided. The method includes sending, by a first entity, a message to a second entity, wherein the message comprises an identity of the first entity, and sending, by the second entity, a message to the first entity, wherein the message comprises information indicating whether an adjacent home base station and the first entity are serviced by a same gateway.

In accordance with another aspect of the present invention, a method for receiving information of a relation between home base stations is provided. The method includes sending, by a first entity, a message to a second entity, wherein the message comprises an identity of the first entity, and receiving, by the first entity, a message from the second entity, wherein the message comprises information indicating whether an adjacent home base station and the first entity are serviced by a same gateway.

In accordance with another aspect of the present, a method for transmitting information of a relation between home base stations is provided. The method includes receiving, by a second entity, a message from a first entity, wherein the message comprises an identity of the first entity, and sending, by the second entity, a message to the first entity, wherein the message comprises information indicating whether an adjacent home base station and the first entity are serviced by a same gateway.

By using exemplary methods described by the present invention, the UE can continuously receive data when moving between home base stations, so as to decrease signaling interaction with the core network, and thus decrease the load of the core network. Moreover, exemplary embodiments of the present invention support the core network defined in older versions.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a structure of a home base station in a Long Term Evolution (LTE) system according to the related art.

FIG. 2 illustrates a Universal Mobile Telecommunications System (UMTS) including a Home Node B (HNB) according to an exemplary embodiment of the present invention.

FIG. 3 illustrates a handover procedure between Home Node Bs (HNBs) in a UMTS according to an exemplary embodiment of the present invention.

FIG. 4 illustrates a handover procedure between Home evolved Node Bs (HeNBs) in an LTE system according to an exemplary embodiment of the present invention.

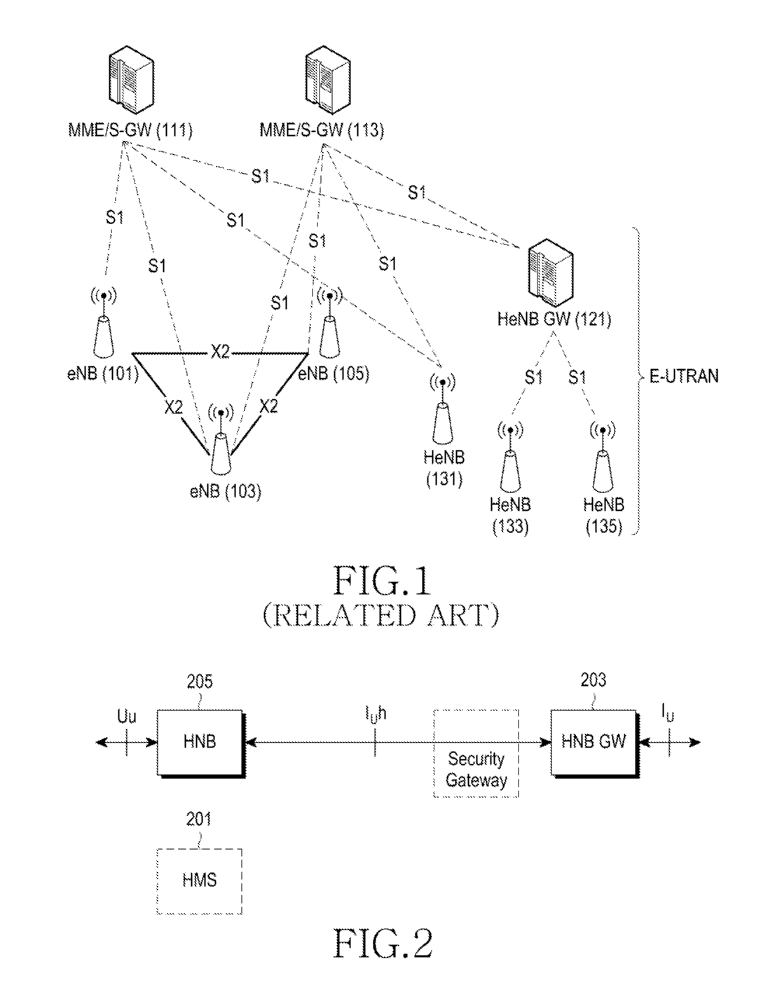

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

According to exemplary embodiments of the present invention, whether a source home base station and a target home base station are serviced by the same gateway is determined, if the target home base station and the source home base station are not serviced by the same gateway, the handover procedure is the same as a current handover procedure. On the other hand, if the target home base station and the source home base station are serviced by the same gateway, a handover procedure according to exemplary embodiments of the present invention is used. The current handover procedure refers to section 5.5.1 (S1 handover procedure in the Long Term Evolution (LTE) system) of Technical Specification (TS) 23.401 in the 3^{rd} Generation Partnership Project (3GPP) protocol and section 6.9.2.2 (a relocation process in the Universal Mobile Telecommunications System (UMTS)) of TS 23.060 in the 3GPP protocol.

According to an exemplary embodiment of the present invention, a first entity may be a Home Node B (HNB) in the UMTS, or a Home evolved Node B (HeNB) in the LTE system, and a second entity may be an HNB Management System (HMS) or a home base station gateway. The first entity sends a message to the second entity that includes at least an indication of the identity of the first entity. The second entity sends a response message that includes information indicating whether an adjacent home base station and the first entity are serviced by the same gateway. The information can be obtained from information of the response message, wherein the information indicates whether an adjacent home base station and the first entity are serviced by the same gateway. The information may be a range of a routing area supported/controlled by the home base station gateway or a range of a Radio Network Controller (RNC) ID supported/controlled by the home base station gateway.

The first entity receives information through a User Equipment (UE) and determines, according to configuration information of adjacent cells stored by the first entity, whether an identity of a routing area of an adjacent home base station or an RNC ID of the adjacent home base station is within the control range of the gateway, so as to determine whether the adjacent home base station and the first entity are serviced by the same gateway.

Hereafter, an exemplary handover procedure between a target home base station and a source home base station that are serviced by the same gateway is described.

A first exemplary embodiment describes a handover procedure between HNBs in a UMTS. In that procedure, a source HNB obtains, from an HMS, information indicating whether an adjacent HNB and the source HNB are serviced by the same gateway.

A second exemplary embodiment describes a handover procedure between HeNBs in the LTE system. In that procedure, a source HeNB obtains, from a base station gateway, information indicating whether an adjacent HeNB and the source HeNB are serviced by the same gateway.

### First Exemplary Embodiment

The first exemplary embodiment describes a handover procedure between HNBs in a UMTS.

FIG. 2 illustrates a UMTS including an HNB according to an exemplary embodiment of the present invention.

Referring to FIG. 2, an HMS 201 configures essential parameters for an HNB gateway (GW) 203 (called a gateway for short). The essential parameters may include an RNC ID of the HNB GW 203 and a Location Area Identity/Routing Area Identity list (LAI/RAI list) of HNBs supported by the HNB GW 203. In the example of FIG. 2, an HNB 205 may be considered the first entity and the HMS 201 may be considered the second entity.

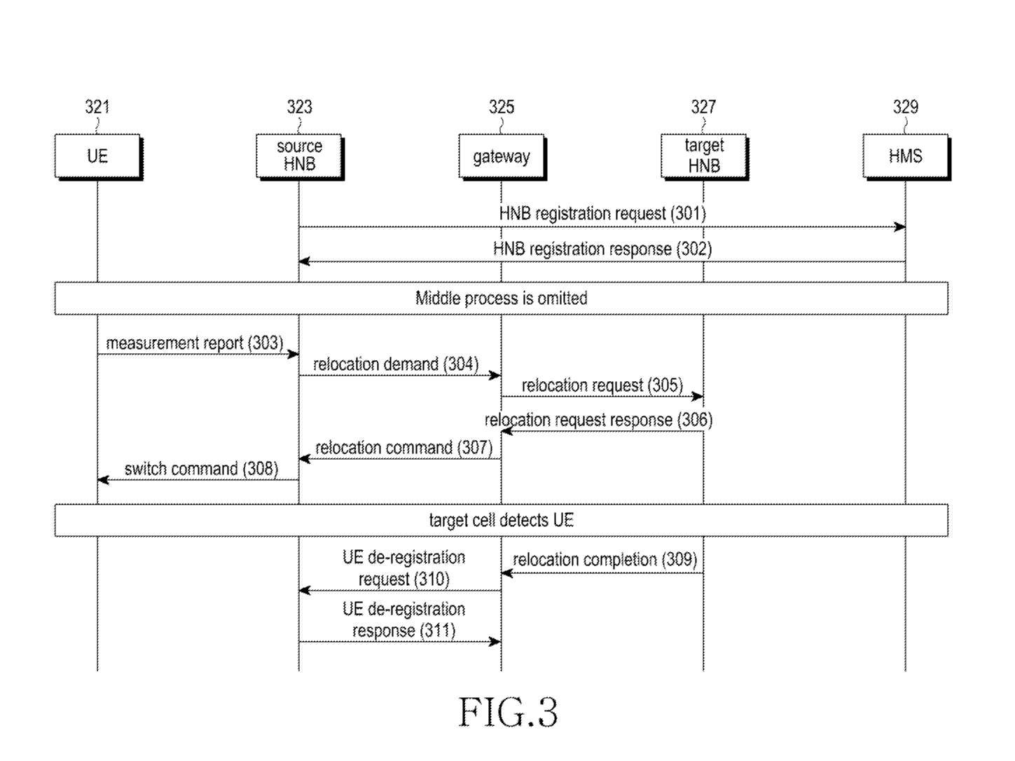

FIG. 3 illustrates a handover procedure between HNBs in a UMTS according to an exemplary embodiment of the present invention.

Referring to FIG. 3, in step 301, when a source HNB 323 (also referred to as “the first entity”) is powered on, it performs a registration process with an HMS 329 wherein it searches adjacent cells, and receives broadcast information regarding adjacent or neighboring HNBs and other information of the adjacent cells, e.g. an identity of a cell (Cell ID), and an LAI/RAI of an HNB of the cell.

In step 302, the HMS 329 configures essential parameters for the source HNB 323. The essential parameters configured for the source HNB 323 may include an RNC identity (RNC ID) of the source HNB 323, and a Cell ID of the cell supported by the source HNB 323. In the example of FIG. 3, it is assumed that one HNB only supports one cell. If one HNB supports multiple cells, the essential parameters may include multiple cell identities. The essential parameters may further include an identity of an accessed Closed Subscriber Group (CSG) (CSG ID) and an accessed International Mobile Subscriber Identity (IMSI) list.

The essential parameters configured for the source HNB 323 may further include configuration information of an adjacent macro cell, which includes an RNC ID, an LAI/RAI, downlink frequency, and scrambling code information of the adjacent macro cell. In order to support the handover procedure between HNBs, the configuration information may further include configuration information of an adjacent HNB, which includes an RNC ID of the adjacent HNB, an LAI/RAI, a Cell ID of the cell supported by the adjacent HNB, downlink frequency, scrambling code information of the adjacent HNB, and the like.

The essential parameters configured for the HNB may include information indicating whether the adjacent HNB and the source HNB 323 are serviced by the same gateway.

The information indicating whether the adjacent HNB and the source HNB 323 are serviced by the same gateway may be specific information within the configuration information of the adjacent HNB, for example a single bit of information within the configuration information. If the specific information is configured as “Yes”, it indicates that the adjacent HNB and the source HNB 323 are serviced by the same gateway. On the other hand, if the information is configured as “No”, it indicates that the adjacent HNB and the source HNB 323 are not serviced by the same gateway.

When a UE 321 that is in a connection state needs to be switched from the source HNB 323 (i.e. the first entity) to a target HNB 327 (i.e., needs to perform a handover), the source HNB 323 receives a measurement report from the UE 321. The measurement report may include measured scrambling code information of the target HNB 327. In an exemplary implementation, the source HNB 323 has stored therein the configuration information of the target HNB 327, which includes scrambling code information, a Cell ID, and information indicating whether the target HNB 327 and the source HNB 323 are serviced by the same gateway. According to the scrambling code of the target HNB 327 reported by the UE 321, the source HNB 323 finds the configuration information of the target HNB 327 corresponding to the scrambling code. The configuration information indicates whether the target HNB 327 and the source HNB 323 are serviced by the same gateway.

The information indicating whether the target HNB 327 and the source HNB 323 are serviced by the same gateway may be implicit indication information. For example, the configuration information received by the source HNB 323 may only include information of adjacent HNBs serviced by the same gateway. The first entity, i.e. the source HNB 323, receives the measurement report of the UE 321 and searches the stored configuration information of the adjacent HNB. If the configuration information is not stored, it is an indication that the target HNB 327 and the source HNB 323 are not serviced by the same gateway.

The information indicating whether the target HNB 327 and the source HNB 323 are both serviced by the gateway 325 may include an LAI/RAI list or a Location Area Code/Routing Area Code (LAC/RAC) list of HNBs supported by the gateway 325. In an exemplary implementation, if an LAC/RAC used by the target HNB 327 of the source HNB 323 is within a range, it indicates that the target HNB 327 and the source HNB 323 are serviced by the same gateway. When the first entity, i.e. the source home base station 323, receives the measurement report of the UE 321, which includes the scrambling code information of the target HNB 327, because the source HNB 323 has stored therein the configuration information of the target HNB 327, which includes a scrambling code, a Cell ID, an RAI, and so on, the source HNB 323 may learn an RAI used by the target HNB 327. Further, once the source HNB 323 has learned the LAI/RAI list or the LAC/RAC list supported/controlled by the gateway 325, the source HNB 323 can determine whether the target HNB 327 and the source HNB 323 are serviced by the same gateway 325 according to the above information.

The information indicating whether the target HNB 327 and the source HNB 323 are serviced by the same gateway 325 may be an RNC ID list supported by the gateway 325, or an RNC ID range supported by the gateway 325. Under one gateway, there are multiple HNBs, and one RNC ID is allocated to each HNB. Under one gateway, the RNC ID, which can be allocated, has a range, wherein different ranges are used under different gateways, and the range is an RNC ID range supported by the gateway.

For example, RNC ID=2 may be allocated to the source HNB 323, wherein the range of RNC IDs supported by the gateway 325 is from 1 to 5. Thus, if the RNC ID allocated to an HNB that is adjacent the source HNB 323 is within the range, it indicates that the adjacent HNB and the source HNB 323 are serviced by the same gateway. If one gateway only supports one RNC ID, the same RNC ID is allocated to all HNBs serviced by the gateway. When the UE 321, in a connection mode, is switched from the first entity, i.e. the source HNB 323, to the target HNB 327, the source HNB 323 receives the measurement report of the UE 321 first, which includes scrambling code information of the target HNB 327, because the source HNB 323 has stored therein the configuration information of the target HNB 327, which includes a scrambling code, a Cell ID, an RAI, and so on. Using that information, the source HNB 323 may determine an RNC ID used by the target HNB 327. Further, the source HNB 323 has also learned the RNC ID range or the RNC ID list supported by the gateway 325, and thus the source HNB 323 can determine whether the target HNB 327 and the source HNB 323 are serviced by the same gateway according to the above information.

The following process includes the source HNB 323 registering at the gateway 325 and the gateway 325 receiving the registration. If the UE 321 accesses the source HNB 323, the UE 321 needs to establish an RNC connection with the source HNB 323, and the source HNB 323 performs registration at the gateway 325. This process, which is substantially the same as the prior art, may be performed according to the fifth section of TS 25.467 in the 3GPP protocol, and will not be described in detail. In the following exemplary process, it is assumed that the UE 321 accesses the source HNB 323 and that the UE 321 is in a connection state with the source HNB 323. The UE 321 measures adjacent cells, and reports a measurement result to the source HNB 323.

An exemplary handover procedure between HNBs in the UMTS is described hereinafter.

In step 303, the source HNB 323 receives the measurement report sent by the UE 321, which includes measurement information and a scrambling code of adjacent HNBs including the target HNB 327.

After obtaining the measurement report, the source HNB 323 determines whether to switch the user to one of the adjacent HNBs. The source HNB 323 stores information of the adjacent HNBs, e.g., a scrambling code, an identity, an RNC ID, an RAI of the adjacent HNBs, and the like. In the illustrated example of FIG. 3 and for discussion purposes below, it is assumed that the target HNB 327 is the adjacent HNB. According to the information indicating whether the target HNB 327 and the source HNB 323 are serviced by the same gateway obtained in step 302, the source HNB 323 may determine whether the target HNB 327 and the source HNB 323 are serviced by the same gateway 325. For example, the source HNB 323 stores an RAI range supported by the gateway 325. According to the RAI range, the source HNB 323 may determine whether the target HNB 327 and the source HNB 323 are serviced by the same gateway 325.

In step 304, if it is determined that the target HNB 327 and the source HNB 323 are serviced by the same gateway 325, the source HNB 323 sends a relocation demand message to the gateway 325. The relocation demand message may include identities of the source HNB 323 and the target HNB 327, information of a transparent packet from a source RNC to a target RNC, and so on. The relocation demand message may further include encryption information, e.g., a supported integrality protection algorithm and a corresponding key, a supported encryption algorithm and a corresponding key, and the like.

The source HNB 323 may also send an enhanced switch request message to the gateway 325, which includes a transparent packet from a source RNC to a target RNC, an old signaling connection identity, Radio Access Bearer (RAB) information to be established, a supported integrality protection algorithm, and a corresponding key, and a supported encryption algorithm and a corresponding key. The transparent packet from the source RNC to the target RNC may include an integrality protection algorithm and a key selected by a source cell, an encryption algorithm and a key selected by the source cell, an identity of the target HNB 327, and so on.

In step 305, if the gateway 325 receives the relocation demand message, the gateway 325 parses the identity of the target HNB 327 in the transparent packet from the source RNC to the target RNC to obtain an address of the target HNB 327, and sends a relocation request message to the target HNB 327. The relocation request message may include encryption information, RAB information to be established, and so on.

If the gateway 325 receives an enhanced switch request message, the gateway 325 needs to obtain the address of the target HNB 327, and forward an enhanced relocation request message to the target HNB 327.

In step 306, the target HNB 327 sends a response message to the gateway 325.

According to the message received in step 305, the response message may be a relocation request response message sent to the gateway 325, which includes the encryption algorithm and the integrity protection algorithm selected by the target HNB 327, the successfully established RAB information, and unsuccessfully established RAB information.

Or, the response message may be an enhanced relocation response message, which includes the encryption algorithm and the integrity protection algorithm selected by the target HNB 327, the successfully established RAB information, and unsuccessfully established RAB information.

In step 307, the gateway 325 sends a message to the source HNB 323 that the target HNB 327 has reserved or otherwise available resources and the UE 321 may be switched to the target HNB 327.

According to the message received in step 306, the message in step 307 may be a relocation command or an enhanced relocation response sent to the source HNB 323.

In step 308, the source HNB 323 sends a switch command to the UE 321 to switch to the target HNB 327.

In step 309, the target HNB 327 detects the UE 321, and sends a relocation completion message to the gateway 325.

In step 310, the gateway sends a UE de-registration request message to the source HNB 323, and deletes context information of the UE 321.

In step 311, the source HNB 323 sends a UE de-registration response message to the gateway 325.

It should be noted that, the technical scheme of the above exemplary embodiment is also applicable to the HeNB. When the technical scheme is applied to the HeNB, names of the parameters need to be modified correspondingly.

### Second Exemplary Embodiment

The second exemplary embodiment describes a handover procedure between home base stations (HeNBs) in an LTE system.

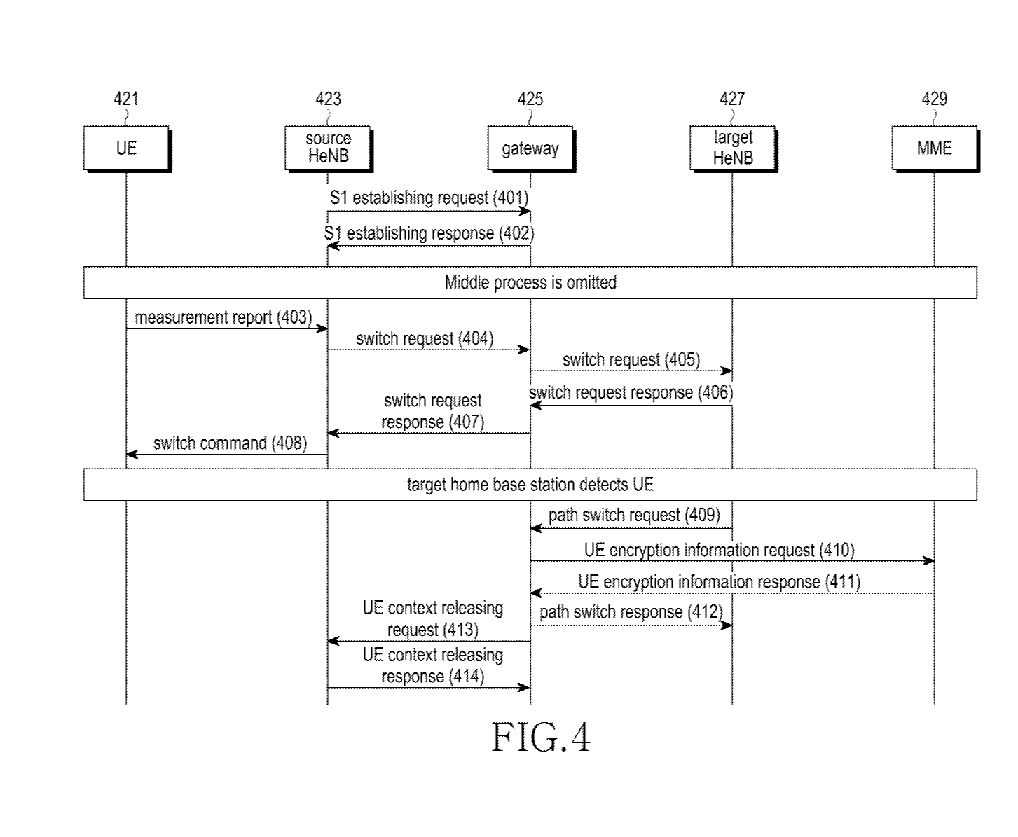

FIG. 4 illustrates a handover procedure between HeNBs in an LTE system according to an exemplary embodiment of the present invention.

Referring to FIG. 4, when an HeNB is powered on, the HeNB, i.e. the first entity, needs to exchange information with an HMS, and obtains configuration parameters from a Mobility Management Entity (MME), i.e. the second entity. The first entity, i.e. the HeNB, may obtain information from the MME by using the method of the first exemplary embodiment, and determine, according to the information, whether an adjacent HeNB and the first entity are serviced by the same gateway. In the LTE system, the gateway uses a group of exclusive Tracking Area Identities (TAIs), and the MME may send an identity of the gateway and a TAI list supported by the gateway to the HeNB. When the first entity, i.e. the HeNB, receives a measurement report from the user, it may include an identity of an adjacent HeNB, a TAI, and a measurement result. The HeNB may determine whether the adjacent HeNB and the first entity are serviced by the same gateway according to the TAI reported by the UE and the TAI list of the gateway configured by the MME. The exemplary method as is similar to the exemplary method described above with reference to FIG. 3.

In step 401, after the source HeNB 423 (also referred to as “a first entity”) is powered on, the source HeNB 423 sends a message to a gateway 425 (also referred to as “a second entity”), and establishes an interface to the gateway 425. The name of the message is S1 establishing request, and the message includes an identity of the source HeNB 423, an identity of an operator supported by the source HeNB 423, e.g. a Public Land Mobile Network, (PLMN), and a Tracking Area Code (TAC) supported by the source HeNB 423.

In step 402, the gateway 425 (the second entity) sends to the source HeNB 423 an S1 establishing response message, which includes an identity of an operator supported by a core network, e.g. a PLMN, an MME 429 and Mobility Management Entity Code (MMEC). The message further includes one or both of a TAC list supported by the gateway, and a TAI list (the TAI is equal to the PLMN plus the TAC). The gateway 425 in the LTE system is identified by a group of exclusive TAC lists in one operator system. Different gateways use different TAC lists.

In the following process, it is assumed that the UE 421 is serviced by the source HeNB 423, and is in a connection state. The UE 421 sends a measurement report to the source HeNB 423, and the source HeNB 423 initiates a handover procedure to a target HeNB 427.

In step 403, the first entity, i.e. source HeNB 432, receives the measurement report sent by the UE 421, which includes measurement information of a target HeNB 427. The measurement report includes identities of cells (Cell IDs) supported by the adjacent HeNBs, and a TAI of the adjacent HeNBs.

In step 404, after obtaining the measurement report, the source HeNB 423 determines whether to switch the UE 421 to the target HeNB 427. According to a TAI list supported by the gateway 425 and the TAI of the target HeNB 427 reported by the UE 421, the source HeNB 423 may determine whether the target HeNB 427 and the source HeNB 423 are serviced by the same gateway 425.

If the target HeNB 427 and the source HeNB 423 are serviced by the same gateway 425, the source HeNB 423 initiates a switch request message, which includes an identity of the target HeNB 427, context information of the UE 421, and an identity of the UE 421 in the source HeNB 423. The message further includes a CSG ID supported by the source HeNB 423.

In step 405, the gateway 425 receives the switch request message. If the source HeNB 423 and the target HeNB 427 have established an X2 interface, the gateway 425 may directly forward the switch request message to the target HeNB 427. If the source HeNB 423 and the target HeNB 427 have not established an X2 interface, the gateway 425 parses the identity of the target HeNB 427 in the switch request message to obtain an address of the target HeNB 427, and then sends the switch request message to the target HeNB 427.

In step 406, the target HeNB 427 sends a switch response message to the gateway 425.

In step 407, the gateway 425 forwards the switch response message to the source HeNB 423.

In step 408, the source HeNB 423 sends a switch command message to the UE 421.

In step 409, the UE 421 is switched to the target HeNB 427. The target HeNB 427 detects the UE 421, sends a path switch request message to the gateway 425, and informs the gateway 425 to switch the user to the target HeNB 427. The message may include an identity of the target HeNB 427, a TAI, the encryption capability of the UE 421, downlink RAB information of the target HeNB 427, and the RAB information includes an identity of the RAB, and address information of a transport layer.

In step 410, the gateway 425 can not generate new encryption information, and sends an encryption information request message to the MME 429, which includes the identity of the UE 421, the identity of the target HeNB 427, and the TAI of the target HeNB 427.

In step 411, the MME 429 sends an encryption information response message to the gateway 425, which includes an encrypted context.

In step 412, the gateway 425 sends a path switch response to the target HeNB 427, which includes the identity of the UE 421, the encrypted context, uplink RAB information of a new cell to be switched to (RAB information), and the RAB information includes the identity of the RAB and the address information of the transport layer.

In step 413, the gateway 425 sends a UE 421 context releasing request message to the source HeNB 423, and releases the UE information in the source HeNB 423.

In step 414, the source HeNB 423 sends a corresponding message.

It should be noted that, the technical scheme of the above exemplary embodiments is also applicable to the HNB. When the technical scheme is applied to the HNB, in the step 402, the gateway 425 sends the range of the RNC ID or the range of the RAI supported by the gateway 425 to the HNB, and the names of messages or information elements in other steps are modified correspondingly.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for transmitting and receiving information of a relation between home base stations, the method comprising:
sending, by a first entity, a message to a second entity, wherein the message comprises an identity of the first entity; and
sending, by the second entity, a message to the first entity, wherein the message comprises information indicating whether an adjacent home base station and the first entity are serviced by a same gateway.

2. The method of claim 1, wherein the first entity comprises at least one of a home base station in a Long Time Evolution (LTE) system and a home base station in a Universal Mobile Telecommunications System (UMTS).

3. The method of claim 1, wherein the second entity comprises at least one of a Home Node B (HNB) Management System (HMS) and a home base station gateway.

4. The method of claim 1, wherein the information indicating whether the adjacent home base station and the first entity are serviced by the same gateway comprises an implicit indication.

5. The method of claim 3, wherein the information indicating whether the adjacent home base station and the first entity are serviced by the same gateway comprises a Tracking Area Code (TAC) supported by the home base station gateway.

6. The method of claim 3, wherein the information indicating whether the adjacent home base station and the first entity are serviced by the same gateway comprises a range of a Radio Network Controller identity (RNC ID) supported by the home base station gateway.

7. The method of claim 1, further comprising:
receiving, by the first entity, a measurement report of User Equipment (UE), and determining, by the first entity, whether to switch the UE to a target home base station;
determining, by the first entity, whether the target home base station and the first entity are serviced by the same gateway; and
if the target home base station and the first entity are serviced by the same gateway, sending a switch request message to the gateway.

8. The method of claim 7, wherein the switch request message comprises encryption information.

9. The method of claim 7, further comprising:
if the first entity determines that the target home base station and the first entity are not serviced by the same gateway, sending, by the first entity, a switch demand message to the gateway.

10. The method of claim 3, further comprising:
requesting, by the home base station gateway, a core network to obtain encryption information of the UE.

11. A method for receiving information of a relation between home base stations, the method comprising:
sending, by a first entity, a message to a second entity, wherein the message comprises an identity of the first entity; and
receiving, by the first entity, a message from the second entity, wherein the message comprises information indicating whether an adjacent home base station and the first entity are serviced by a same gateway.

12. The method of claim 11, wherein the first entity comprises at least one of a home base station in a Long Time Evolution (LTE) system and a home base station in a Universal Mobile Telecommunications System (UMTS).

13. The method of claim 11, wherein the second entity comprises at least one of a Home Node B (HNB) Management System (HMS) and a home base station gateway.

14. The method of claim 11, wherein the information indicating whether the adjacent home base station and the first entity are serviced by the same gateway comprises an implicit indication.

15. The method of claim 13, wherein the information indicating whether the adjacent home base station and the first entity are serviced by the same gateway comprises a Tracking Area Code (TAC) supported by the home base station gateway.

16. The method of claim 13, wherein the information indicating whether the adjacent home base station and the first entity are under the same gateway comprises a range of a Radio Network Controller identity (RNC ID) supported by the home base station gateway.

17. The method of claim 11, further comprising:
receiving, by the first entity, a measurement report of User Equipment (UE), and determining, by the first entity, to switch the UE to a target home base station;
determining, by the first entity, whether the target home base station and the first entity are serviced by the same gateway; and
if the target home base station and the first entity are serviced by the same gateway, sending a switch request message to the gateway.

18. The method of claim 17, wherein the switch request message comprises encryption information.

19. The method of claim 17, further comprising:
if the first entity determines that the target home base station and the first entity are not serviced by the same gateway, sending, by the first entity, a switch demand message to the gateway.

20. A method for transmitting information of a relation between home base stations, the method comprising:
receiving, by a second entity, a message from a first entity, wherein the message comprises an identity of the first entity; and
sending, by the second entity, a message to the first entity, wherein the message comprises information indicating whether an adjacent home base station and the first entity are serviced by a same gateway.

21. The method of claim 20, wherein the first entity comprises at least one of a home base station in a Long Time Evolution (LTE) system and a home base station in a Universal Mobile Telecommunications System (UMTS).

22. The method of claim 20, wherein the second entity comprises at least one of a Home Node B (HNB) Management System (HMS) and a home base station gateway.

23. The method of claim 20, wherein the information indicating whether the adjacent home base station and the first entity are serviced by the same gateway comprises an implicit indication.

24. The method of claim 22, wherein the information indicating whether the adjacent home base station and the first entity are serviced by the same gateway comprises a Tracking Area Code (TAC) supported by the home base station gateway.

25. The method of claim 22, wherein the information indicating whether the adjacent home base station and the first entity are serviced by the same gateway comprises a range of a Radio Network Controller identity (RNC ID) supported by the home base station gateway.

26. The method of claim 22, further comprising:
requesting, by the home base station gateway, a core network to obtain encryption information of the UE.
